(19) United States
(12) Patent Application Publication
(10) Pub. No.: US 2012/0195713 A1
(43) Pub. Date: Aug. 2, 2012

(54) FASTENING MEMBER WITH EXTERNAL THREADS AND THREADED FASTENING ASSEMBLY

(75) Inventors: James Mao Zhong Gu, Shanghai (CN); Shuqing Peng, Shanghai (CN)

(73) Assignee: SHANGHAI DETROIT PRECISION FASTENER CO., LTD., Shanghai (CN)

(21) Appl. No.: 13/063,707

(22) PCT Filed: Jan. 31, 2011
(86) PCT No.: PCT/CN2011/070850

§ 371 Date: Mar. 28, 2012

(30) Foreign Application Priority Data
Dec. 17, 2010 (CN) 201010599126.7

(51) Int. Cl. F16B 35/00

(52) U.S. Cl. 411/411

(57) ABSTRACT

The invention discloses a fastening member with external threads, which is capable of mating with a fastening member with internal threads via the external threads and the internal threads; each external thread includes a leading flank and a trailing flank; the external thread further includes an oblique surface extending between the leading flank of the external thread and the trailing flank of the external thread; a joint between the oblique surface of the external thread and the leading flank of the external thread is farther away from an axis the external thread, compared with a joint between the oblique surface of the external thread and the trailing flank of the external thread; the oblique surface of the external thread is attached against the oblique surface of the internal thread. The invention also provides a threaded fastening assembly. The external thread of the invention mates with the self-locking internal thread structure, such that “thread stripping” does not tend to occur between the surfaces in contact of the external thread and the internal thread, whereby the axial force of the external thread may be kept when the fastening member is used, and then the clamping force of the fastening member with the internal threads may be kept.

### TECHNICAL FIELD

The invention relates to a threaded fastening member, and more particularly to a fastening member with external threads and a threaded fastening assembly including the fastening member.

### BACKGROUND OF THE INVENTION

The thread is an essential element for the threaded coupling. The triangular thread has a large equivalent coefficient of friction and good self-locking performance, and then it is mainly used in connection. When the metric or American thread standard is adopted, the flank angle of the triangular thread is 30°; when the British thread standard is adopted, the flank angle of the triangular thread is 27.5°.

U.S. Pat. No. 4,171,012 discloses a self-locking thread structure. As shown in FIG. 1, the self-locking thread structure is an internal thread 1. Each internal thread 1 includes a leading flank 11, a trailing flank 12 and an oblique surface extending therebetween. The joint between the oblique surface 13 and the leading flank 11 is higher than the joint between the oblique surface 13 and the trailing flank 12. That is, the joint between the oblique surface 13 and the leading flank 11 is farther away from the axis 3 of the internal thread 1, compared with the joint between the oblique surface 13 and the trailing flank 12. No matter which one of the metric, American and British thread standards is adopted, the included angle between the oblique surface 13 and the axis 3 of the internal thread 1 is always in a range of 15° to 45°, preferably 30°.

The fundamental triangle of the internal thread 1 is a triangle meeting the metric, American or British thread standard. That is, when the metric or American thread standard is adopted, the flank angle of the leading flank 11 of the internal thread 1 is 30°; when the British thread standard is adopted, the flank angle of the leading flank 11 of the internal thread 1 is 27.5°. Certainly, the fundamental triangle of the internal thread 1 also may be a triangular thread with an increased flank angle of the leading flank 11, or may be a triangular thread with an increased flank angle of the trailing flank 12. That is, the flank angle of the leading flank 11 is larger than 30° and/or the flank angle of the trailing flank 12 is larger than 27.5°.

At present, as shown in FIG. 1, an external thread 2 mating with the self-locking thread structure is a triangular thread meeting the metric, American or British thread standard. Each external thread 2 includes a leading flank 21, a trailing flank 22, and a crest 23 and root 24 extending between the leading flank 21 and the trailing flank 22. The crest 23 usually is a flat surface parallel to the axis 3 of the external thread 2 (it is also the axis 3 of the internal thread 1, wherein the axis of the internal thread 1 coincides with the axis of the external thread 2). To overcome the issue of stress concentration, the root 24 is usually a circular arc surface. When the external thread 2 generates an axial force F, the crest 23 of the external thread 2 abuts against the oblique surface 13 of the internal thread 1.

The crest 23 of the external thread 2 makes line contact with the oblique surface 13 of the internal thread 1, and then the contact area is small, while the contact stress is large. Thus, “cold welding” tends to occur on the portions in contact, which would lead to the phenomenon of “thread stripping”. In the process of using the screw pair, the portions in contact would continue making slight compression deformation due to the long-time vibration of the machine or the retained workpiece, which would decrease the axial force of the external threads, and then the clamping force of the fastening member with the internal threads decreases.

### SUMMARY OF THE INVENTION

In view of the above disadvantages in the prior art, the technical problem to be solved by the invention is to provide a fastening member with external threads and a threaded fastening assembly, and the external thread mates with a self-locking internal thread structure, such that the “thread stripping” does not tend to occur between the surfaces in contact of the external threads and internal threads, whereby the axial force of the external threads may be kept when the fastening member is used and then the clamping force of the fastening member with the internal threads is kept.

To achieve the above objective, the invention provides a fastening member with external threads, which is capable of mating with a fastening member with internal threads via the external threads and the internal threads, and each internal thread includes a leading flank, a trailing flank and an oblique surface extending between the leading flank of the internal thread and the trailing flank of the internal thread; the joint between the oblique surface of the internal thread and the leading flank of the internal thread is farther away from the axis of the internal thread, compared with the joint between the oblique surface of the internal thread and the trailing flank of the internal thread; each external thread includes a leading flank and a trailing flank; the external thread further includes an oblique surface extending between the leading flank of the external thread and the trailing flank of the external thread; the joint between the oblique surface of the external thread and the leading flank of the external thread is farther away from the axis of the external thread, compared with the joint between the oblique surface of the external thread and the trailing flank of the external thread; the oblique surface of the external thread is attached against the oblique surface of the internal thread.

Further, an included angle between the oblique surface of the external thread and the axis of the external thread is in a range of 15° to 45°.

Preferably, the included angle between the oblique surface of the external thread and the axis of the external thread is 30°.

Preferably, when the metric or American thread standard is adopted, the flank angle of the leading flank of the internal thread and the flank angle of the trailing flank of the internal thread are both equal to 30°; when the British thread standard is adopted, the flank angle of the leading flank of the internal thread and the flank angle of the trailing flank of the internal thread are both equal to 27.5°.

Alternatively, when the metric or American thread standard is adopted, the flank angle of the leading flank of the internal thread is larger than 30°, and the flank angle of the trailing flank of the internal thread is equal to 30°; when the British thread standard is adopted, the flank angle of the leading flank of the internal thread is larger than 27.5°, and the flank angle of the trailing flank of the internal thread is equal to 27.5°.

Alternatively, when the metric or American thread standard is adopted, the flank angle of the leading flank of the internal thread is equal to 30°, and the flank angle of the trailing flank of the internal thread is larger than 30°; when the British thread standard is adopted, the flank angle of the leading flank of the internal thread is equal to 27.5°, and the flank angle of the trailing flank of the internal thread is larger than 27.5°.

Alternatively, when the metric or American thread standard is adopted, the flank angle of the leading flank of the internal thread is larger than 30°, and the flank angle of the trailing flank of the internal thread is larger than 30°; when the British thread standard is adopted, the flank angle of the leading flank of the internal thread is larger than 27.5°, and the flank angle of the trailing flank of the internal thread is larger than 27.5°.

Further, the included angle between the oblique surface of the internal thread and the axis of the internal thread is in a range of 15° to 45°.

Preferably, the fastening member with the external threads is a bolt, and the fastening member with the internal threads capable of mating with the fastening member with the external threads is a nut.

Further, the external thread is formed by rolling or cutting.

The invention also provides a threaded fastening assembly including a first fastening member with external threads and a second fastening member with internal threads, wherein the first fastening member mates with the second fastening member via the external threads and the internal threads; each internal thread includes a leading flank, a trailing flank and an oblique surface extending between the leading flank of the internal thread and the trailing flank of the internal thread; the joint between the oblique surface of the internal thread and the leading flank of the internal thread is farther away from the axis the internal thread, compared with the joint between the oblique surface of the internal thread and the trailing flank of the internal thread; each external thread includes a leading flank and a trailing flank; the external thread also includes an oblique surface extending between the leading flank of the external thread and the trailing flank of the external thread; the joint between the oblique surface of the external thread and the leading flank of the external thread is farther away from the axis of the external thread, compared with the joint between the oblique surface of the external thread and the trailing flank of the external thread; the oblique surface of the external thread is attached against the oblique surface of the internal thread.

Preferably, the first fastening member is a bolt, and the second fastening member is a nut.

The beneficial effects of the fastening member with external threads and the threaded fastening assembly of the invention are described as following:

The external thread also has an oblique surface to mate with the self-locking internal thread structure. That is, the oblique surface of the external thread is attached against the oblique surface of the internal thread. The external thread makes surface contact with the internal thread, so that the contact area is enlarged, and the contact stress is decreased. Therefore, “cold welding” does not tend to occur between the surfaces in contact, and then the phenomenon of “thread stripping” also does not tend to occur. When the threaded fastening assembly is used, the continuing compression deformation of the surfaces in contact is less due to the avoidance of the “thread stripping”, and then the axial force of the external thread may be kept, so as to keep the clamping force of the fastening member with the internal threads.

The included angle between the oblique surface of the self-locking internal thread structure and the axis of the internal thread is in a range of 15° to 45°, preferably 30°. To mate with the self-locking internal thread structure, the included angle between the oblique surface of the external thread of the invention and the axis of the external thread is also in a range of 15° to 45°, preferably 30°.

The fundamental triangle of the self-locking internal thread mating with the external thread of the invention is a triangle meeting the metric, American or British thread standard, and also may be a triangular thread with an increased flank angle of the leading flank or a triangular thread with an increased flank angle of the trailing flank, or a triangular thread with both of the increased flank angle of the leading flank and the increased flank angle of the trailing flank. The internal thread mating with the external thread of the invention just requires to have the oblique surface lying at an included angle in a range of 15° to 45° relative to the axis of the internal thread, without any limitation to the flank angles of the leading flank and the trailing flank.

The conception, specific structure and resulting technical effects of the invention are described further hereinbelow in combination with the appended drawings to facilitate a sufficient understanding of the objectives, characteristics and effects of the invention.

### BRIEF DESCRIPTION OF THE DRAWINGS

FIG. 1 is a sectional schematic diagram showing the threaded coupling between an external thread of the prior art and a self-locking internal thread.

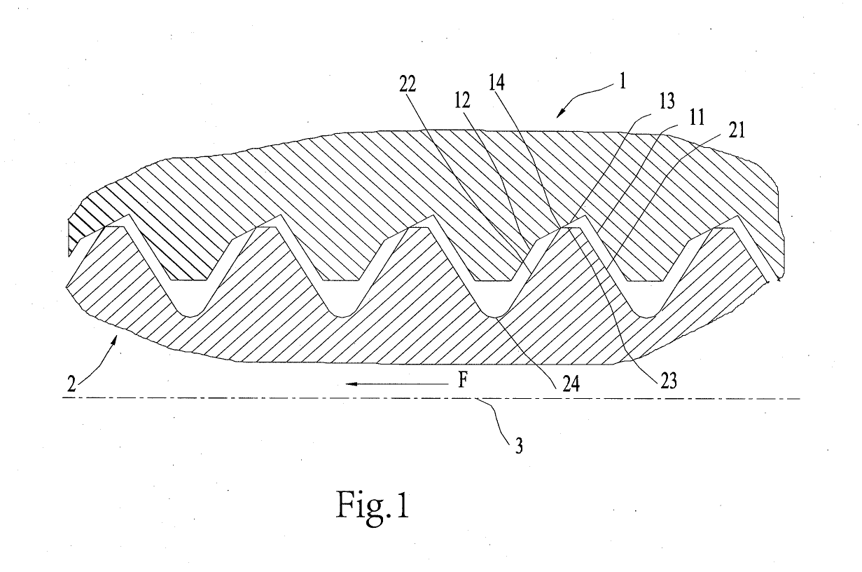

FIG. 2 is a sectional schematic diagram showing an external thread in a preferred embodiment of the invention;

FIG. 3 is a partial enlarged diagram showing the part I in FIG. 2;

FIG. 4 is a sectional schematic diagram showing the threaded coupling between the external thread in FIG. 2 and the self-locking internal thread.

### DETAILED DESCRIPTION OF THE EMBODIMENTS

To illustrate the principle and embodiment of the present invention in detail, a bolt is taken as an example of the fastening member with external threads of the invention, and a nut mating with the bolt is taken as an example of the fastening member with internal threads. However, the present invention is not limited thereto, the fastening member with external threads in the invention may be a part with the external threads of the invention (the material of the part is not limited). The part (such as a screw, a double end stud or a customized part, etc.) may mate with a part (such as a nut) with self-locking thread structure, and it may be used widely in the fields such as automobile, engineering machinery, railway, urban rail, bridge or aviation.

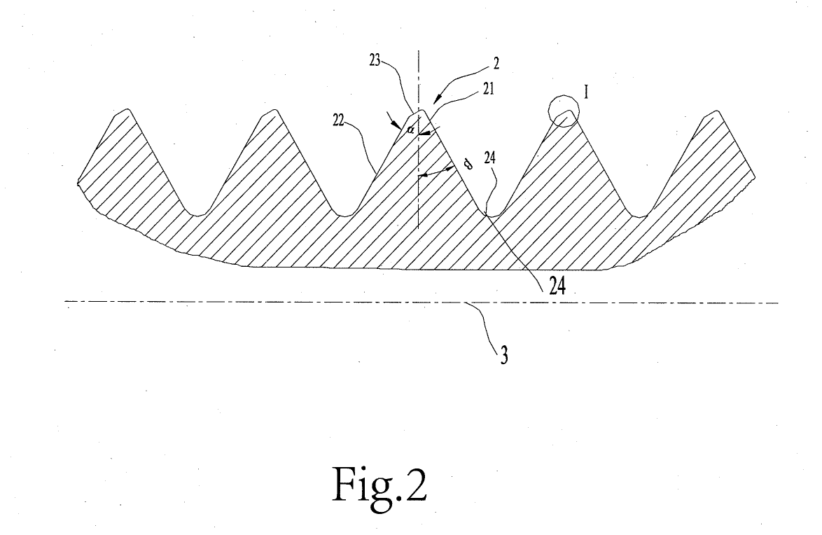

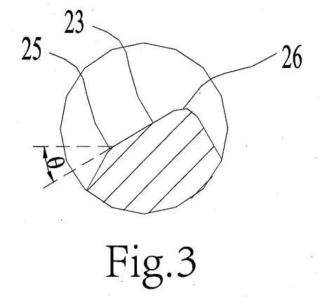

FIG. 2 is a sectional schematic diagram showing an external thread in a preferred embodiment of the invention. As shown in FIG. 2 and FIG. 3, each external thread 2 includes a leading flank 21, a trailing flank 22, and a crest 23 and a root 24 extending between the leading flank 21 and the trailing flank 22. The crest 23 is an oblique surface. Compared with the joint 25 between the oblique surface 23 and the trailing flank 22, the joint 26 between the oblique surface 23 and the leading flank 21 is farther away from the axis 3 of the external thread 2. To mate with the self-locking internal thread, the included angle between the oblique surface 23 of the external thread 2 and the axis 3 of the external thread is also in a range of 15° to 45°. Since the included angle between the oblique surface 13 of the self-locking internal thread and the axis 3 of the internal thread (the axis of the internal thread 1 coincides with the axis of the external thread 2) is preferably 30°, the included angle between the oblique surface 23 of the external thread 2 and the axis 3 of the external thread is also preferably 30°.

The fundamental triangle of the external thread 2 is a triangle meeting the metric, American or British thread standard. When the metric or American standard is adopted, the flank angle β of the leading flank 21 and the flank angle α of the trailing flank 22 are both 30°; when the British thread standard is adopted, the flank angle β of the leading flank 21 and the flank angle α of the trailing flank 22 are both 27.5°.

In this embodiment, to overcome the issue of stress concentration, the root 24 is a circular arc surface. Certainly, the invention is not limited thereto, and the root 24 also may be a flat surface.

FIG. 3 is a partial enlarged diagram showing the part I in FIG. 2. As shown in FIG. 3, the included angle θ between the oblique surface 23 of the external thread 2 and the axis 3 of the external thread is in a range of 15° to 45° (when the metric, American or British thread standard is adopted). In the ideal state, the leading flank 21, the trailing flank 22 and the oblique surface 23 of the external thread 2 are all flat surfaces. However, in practice, to facilitate the processing, both of the joint 26 between the leading flank 21 and the oblique surface 23 and the joint 25 between the trailing flank 22 and the oblique surface 23 are circular arc surfaces.

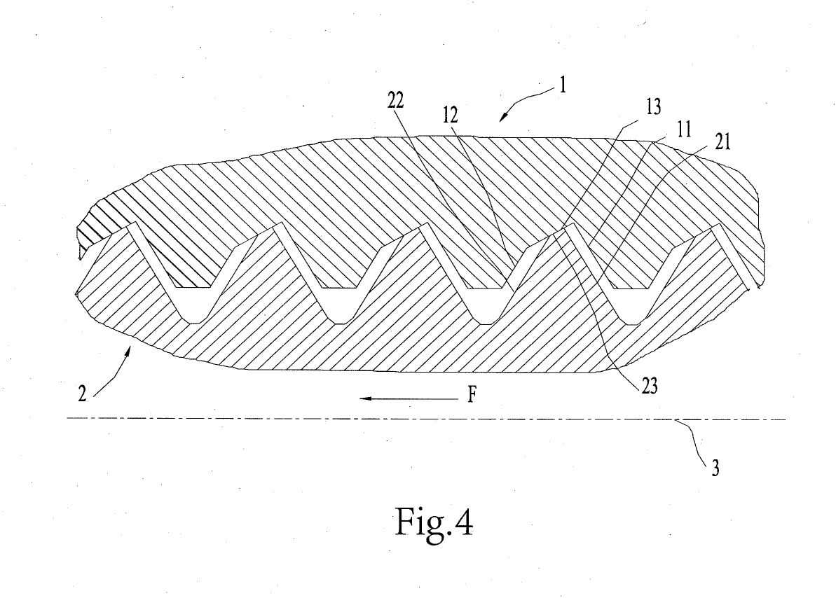

FIG. 4 is a sectional schematic diagram showing the threaded coupling between the external thread in FIG. 2 and the self-locking internal thread. As shown in FIG. 4, each internal thread 1 includes a leading flank 11, a trailing flank 12 and an oblique surface 13 extending between the leading flank 11 and the trailing flank 12. The joint between the oblique surface 13 and the leading flank 11 is higher than the joint between the oblique surface 13 and the trailing flank 12. That is, compared with the joint between the oblique surface 13 and the trailing flank 12, the joint between the oblique surface 13 and the leading flank 11 is farther away from the axis 3 of the internal thread 1. No matter which one of the metric, American and British thread standards is adopted, the included angle between the oblique surface 13 and the axis 3 of the internal thread 1 is always in a range of 15° to 45°, preferably 30°.

In the embodiment of the invention, the fundamental triangle of the internal thread 1 is a triangle meeting the metric, American or British thread standard. When the metric or American thread standard is adopted, the flank angle of the leading flank 11 and the flank angle of the trailing flank 12 are both 30°; when the British thread standard is adopted, the flank angle of the leading flank 11 and the flank angle of the trailing flank 12 are both 27.5°.

The oblique surface 13 of the internal thread 1 is attached against the oblique surface 23 of the external thread 2. The external thread 2 and the internal thread 1 are in surface contact, and then the contact area is larger than that of the line contact in the prior art, such that the contact stress is smaller than that of the line contact in the prior art. Therefore, the “cold welding” does not tend to occur between the surfaces in contact, and the phenomenon of “thread stripping” also does not tend to occur. When the external thread 2 is threadedly coupled with the internal thread 1, the continuing compression deformation of the contact surface is less due to the avoidance of the “thread stripping”, such that the axial force of the external thread 2 may be kept, and then the clamping force of the nut with the internal thread 1 may be kept.

The external thread 2 may be formed by rolling or cutting. Certainly, the invention is not limited thereto, and the external thread 2 also may be processed and formed in other processing manner which may emerge in the future.

The invention is not limited to the embodiment with the internal thread 1 whose fundamental triangle is a triangle meeting the metric, American or British thread standard. The groove width of the internal thread 1 may be increased by increasing the flank angle of the leading flank 11 and/or increasing the flank angle of the trailing flank 12, to allow the bolt with the external threads 2 to be screwed into the nut with the internal threads 1 more smoothly, whereby the oblique surface 23 of the external thread 2 is attached against the oblique surface 13 of the internal thread 1. Thus, the thread pair may achieve a good self-locking function, and the clamping force of the nut may be kept in the usage period of the thread pair.

As an alternative embodiment of the invention, when the metric or American thread standard is adopted, the flank angle of the leading flank 11 of the internal thread 1 is larger than 30°, and the flank angle of the trailing flank 12 of the internal thread 1 is equal to 30°; when the British thread standard is adopted, the flank angle of the leading flank 11 of the internal thread 1 is larger than 27.5°, and the flank angle of the trailing flank 12 of the internal thread 1 is equal to 27.5°.

As another alternative embodiment of the invention, when the metric or American thread standard is adopted, the flank angle of the leading flank 11 of the internal thread 1 is equal to 30°, and the flank angle of the trailing flank 12 of the internal thread 1 is larger than 30°; when the British thread standard is adopted, the flank angle of the leading flank 11 of the internal thread 1 is equal to 27.5°, and the flank angle of the trailing flank 12 of the internal thread 1 is larger than 27.5°.

As still another alternative embodiment of the invention, when the metric or American thread standard is adopted, the flank angle of the leading flank 11 of the internal thread 1 is larger than 30°, and the flank angle of the trailing flank 12 of the internal thread 1 is larger than 30°; when the British thread standard is adopted, the flank angle of the leading flank 11 of the internal thread 1 is larger than 27.5°, and the flank angle of the trailing flank 12 of the internal thread 1 is larger than 27.5°.

The fundamental triangle of the self-locking internal thread 1 mating with the external thread 2 of the invention is a triangle meeting the metric, American or British standard, and also may be a triangular thread with an increased flank angle of the leading flank 11 or a triangular thread with an increased flank angle of the trailing flank 12, or a triangular thread with both of the increased flank angles of the leading flank 11 and the trailing flank 12. The internal thread 1 mating with the external thread 2 of the invention just requires to have the oblique surface 13 lying at an included angle in a range of 15° to 45° relative to the axis 3 of the internal thread 1, without any limitation to the flank angles of the leading flank 11 and the trailing flank 12.

Those of ordinary skill in the art may know about that the internal thread 1 and the external thread 2 have allowable errors in the practical processing, which is different from the ideal state. For example, the joint 26 between the leading flank 21 and the oblique surface 23 and the joint 25 between the trailing flank 22 and the oblique surface 23 are circular arc surfaces in practice instead of straight lines. For another example, when the nut and the bolt are threadedly coupled, the axis of the internal thread 1 coincides with the axis of the external thread 2 in the ideal state; however, in the practical processing, the two axes may deviate from each other slightly instead of being coincident.

The preferred embodiments of the present invention are described in detail hereinbefore. It should be understood that, those of ordinary skill in the art can make various modifications and changes according to the conception of the present invention without the need for creative work. Therefore, all technical solutions obtained by those skilled in the art through logic analysis, reasoning or limited experiments under the conception of the present invention on the basis of the prior art, fall within the protecting scope defined by the appended claims.

1. A fastening member with external threads, capable of mating with a fastening member with internal threads via the external threads and the internal threads,
each internal thread comprising a leading flank, a trailing flank and an oblique surface extending between the leading flank of the internal thread and the trailing flank of the internal thread; a joint between the oblique surface of the internal thread and the leading flank of the internal thread being farther away from an axis of the internal thread, compared with a joint between the oblique surface of the internal thread and the trailing flank of the internal thread;
each external thread comprising a leading flank and a trailing flank,
characterized in that, the external thread further comprises an oblique surface extending between the leading flank of the external thread and the trailing flank of the external thread; a joint between the oblique surface of the external thread and the leading flank of the external thread is farther away from an axis of the external thread, compared with a joint between the oblique surface of the external thread and the trailing flank of the external thread; the oblique surface of the external thread is attached against the oblique surface of the internal thread.

2. The fastening member with external threads according to claim 1, wherein an included angle between the oblique surface of the external thread and the axis of the external thread is in a range of 15° to 45°.

3. The fastening member with external threads according to claim 2, wherein the included angle between the oblique surface of the external thread and the axis of the external thread is 30°.

4. The fastening member with external threads according to claim 1, wherein when metric or American thread standard is adopted, a flank angle of the leading flank of the internal thread and a flank angle of the trailing flank of the internal thread are both equal to 30°; when British thread standard is adopted, the flank angle of the leading flank of the internal thread and the flank angle of the trailing flank of the internal thread are both equal to 27.5°.

5. The fastening member with external threads according to claim 1, wherein when metric or American thread standard is adopted, a flank angle of the leading flank of the internal thread is larger than 30°, and a flank angle of the trailing flank of the internal thread is equal to 30°; when British thread standard is adopted, the flank angle of the leading flank of the internal thread is larger than 27.5°, and the flank angle of the trailing flank of the internal thread is equal to 27.5°.

6. The fastening member with external threads according to claim 1, wherein when metric or American thread standard is adopted, a flank angle of the leading flank of the internal thread is equal to 30°, and a flank angle of the trailing flank of the internal thread is larger than 30°; when British thread standard is adopted, the flank angle of the leading flank of the internal thread is equal to 27.5°, and the flank angle of the trailing flank of the internal thread is larger than 27.5°.

7. The fastening member with external threads according to claim 1, wherein when metric or American thread standard is adopted, a flank angle of the leading flank of the internal thread is larger than 30°, and a flank angle of the trailing flank of the internal thread is larger than 30°; when British thread standard is adopted, the flank angle of the leading flank of the internal thread is larger than 27.5°, and the flank angle of the trailing flank of the internal thread is larger than 27.5°.

8. The fastening member with external threads according to claim 1, wherein an included angle between the oblique surface of the internal thread and the axis of the internal thread is in a range of 15° to 45°.

9. The fastening member with external threads according to claim 1, wherein the fastening member with the external threads is a bolt, and the fastening member with the internal threads capable of mating with the fastening member with the external threads is a nut.

10. The fastening member with external threads according to claim 1, wherein the external thread is formed by rolling or cutting.

11. A threaded fastening assembly, comprising a first fastening member with external threads and a second fastening member with internal threads, wherein the first fastening member mates with the second fastening member via the external threads and the internal threads;
each internal thread comprising a leading flank, a trailing flank and an oblique surface extending between the leading flank of the internal thread and the trailing flank of the internal thread; a joint between the oblique surface of the internal thread and the leading flank of the internal thread being farther away from an axis of the internal thread, compared with a joint between the oblique surface of the internal thread and the trailing flank of the internal thread;
each external thread comprising a leading flank and a trailing flank;
characterized in that, the external thread further comprises an oblique surface extending between the leading flank of the external thread and the trailing flank of the external thread; a joint between the oblique surface of the external thread and the leading flank of the external thread is farther away from an axis of the external thread, compared with a joint between the oblique surface of the external thread and the trailing flank of the external thread; the oblique surface of the external thread is attached against the oblique surface of the internal thread.

12. The threaded fastening assembly according to claim 11, wherein an included angle between the oblique surface of the external thread and the axis of the external thread is in a range of 15° to 45°.

13. The threaded fastening assembly according to claim 12, wherein the included angle between the oblique surface of the external thread and the axis of the external thread is 30°.

14. The threaded fastening assembly according to claim 11, wherein the first fastening member is a bolt, and the second fastening member is a nut.
